(19) United States
(12) Patent Application Publication
(10) Pub. No.: US 2026/0299964 A1
(43) Pub. Date: Oct. 1, 2026

(54) CONFIGURATION RECOMMENDATION GENERATION USING COMBINATORIAL TEST DESIGN MODELING

(71) Applicant: INTERNATIONAL BUSINESS MACHINES CORPORATION, ARMONK, NY (US)

(72) Inventors: TARA ASTIGARRAGA, FAIRPORT, NY (US); ANDREW CHRISTIAN MORRELL HICKS, HIGHLAND, NY (US); PAULINA ACEVEDO, TUCSON, AZ (US); MICHAEL TERRENCE COHOON, FISHKILL, NY (US)

(21) Appl. No.: 19/095,233

(22) Filed: Mar. 31, 2025

(51) Int. Cl. G06F 9/445

(52) U.S. Cl. CPC G06F 9/44505

(57) ABSTRACT

Configuration recommendation generation using Combinatorial Test Design (CTD) modeling according to an example includes generating, by one or more processing devices, a Combinatorial Test Design (CTD) model for identifying possible combinations of stack components for a computing environment stack. The one or more processing devices modify the CTD model based on restrictions indicating invalid stack component combinations. The one or more processing devices apply to the CTD model a plurality of context weights to generate a weighted CTD model. The one or more processing devices generate, based on the weighted CTD model and one or more input parameters, a recommended computing environment stack configuration that includes a valid stack component combination.

### BACKGROUND

The present disclosure relates to methods, apparatus, and products for configuration recommendation generation using Combinatorial Test Design (CTD) modeling.

### SUMMARY

According to embodiments of the present disclosure, various methods, apparatus and products for configuration recommendation generation using Combinatorial Test Design (CTD) modeling are described herein. In some aspects, configuration recommendation generation using Combinatorial Test Design (CTD) modeling includes generating, by one or more processing devices, a CTD model for identifying possible combinations of stack components for a computing environment stack. The one or more processing devices modify the CTD model based on restrictions indicating invalid stack component combinations. The one or more processing devices apply to the CTD model a plurality of context weights to generate a weighted CTD model. The one or more processing devices generate, based on the weighted CTD model and one or more input parameters, a recommended computing environment stack configuration that includes a valid stack component combination.

### BRIEF DESCRIPTION OF THE DRAWINGS

FIG. 1 sets forth an example computing environment according to aspects of the present disclosure.

FIG. 2 sets forth an example configuration recommendation generation engine that uses CTD modeling according to aspects of the present disclosure.

FIG. 3 sets forth a flowchart of an example method for CTD-based configuration recommendation generation according to aspects of the present disclosure.

### DETAILED DESCRIPTION

Some examples disclosed herein use Combinatorial Test Design (CTD) modeling to facilitate the generation of a recommendation for a computing environment stack configuration. Complex computing environments may include hardware, firmware, software, middleware, applications, and services, and this combination of components may be referred to herein as a computing environment stack. Since each component of the computing environment stack may have various versions and configuration options, complex stacks may contain millions of different possible combinations. Some combinations may be supported, working, and tested, while other combinations may be explicitly disallowed. Some combinations may be expected to work together but have not gone through the rigorous testing needed for verification. It is a challenging task to figure out what stack configurations work, what configurations do not work, what stack configurations are supported, what stack configurations are not supported, what stack configurations are valid, and what stack configurations are invalid. Some examples herein use a combination of CTD and other techniques, such as the automatic extraction of documented restrictions for implementation into a CTD model. Some examples use a CTD model to build out what is possible for stack configurations, and then using restrictions to build in what are valid configurations, and then further including information from test execution records to take into account not just what is valid versus what is invalid, but also what component combinations have actually been tested.

Prior to discussing in further detail the use of CTD modeling to facilitate the generation of recommended computing environment stack configurations, the use of CTD modeling in the context of testing a system under test (SUT) will be briefly addressed. A SUT may be, for example, a computer program, a hardware device, firmware, an embedded device, a component thereof, or the like. Testing may be performed using a test suite that includes test cases. The test suite may be reused to revalidate that the SUT exhibits a desired functionality with respect to the tests of the test suite. For example, the test suite may be reused to check that the SUT works properly after a bug is fixed. The test suite may be used to check that the bug is indeed fixed (with respect to a test that previously induced the erroneous behavior). Additionally, or alternatively, the test suite may be used to check that no new bugs were introduced (with respect to other tests of the tests suite that should not be affected by the bug fix).

CTD is a methodology that may be used to optimize test space coverage for a SUT through the use of automated algorithms. These algorithms identify input patterns that are most likely to locate problems in the SUT, thereby reducing the amount of time required for a tester to build test cases and an automation framework. CTD is well-adapted for projects that require numerous variations on static input vectors to properly test various system states and logic pathways, which would otherwise be extremely cumbersome for a human tester.

When CTD is used for testing a SUT, inputs to the SUT may be modeled in a CTD model as a collection of attribute-value pairs. More specifically, inputs to a SUT can be modeled as a collection of attributes, each of which is eligible to take on one or more corresponding attribute values to form attribute-value pairs. For instance, if it is assumed that four different attributes A, B, C, and D are modeled, and if it is further assumed that these attributes can take on four distinct values; three distinct values; three distinct values; and two distinct values, respectively, then the total number of unique combinations of attribute values would be 4*3*3*2=72.

In some examples, a set of CTD test vectors may be generated based on the CTD model from the test space that includes all possible combinations of attribute values. In particular, in some examples, the entire Cartesian product space that contains all possible combinations of attribute-value pairs can be reduced to a smaller set of test vectors that provides complete pairwise coverage, for example, of the test space across all attribute values. For instance, in the example introduced above, the entire Cartesian product space would include 72 different combinations of attribute values. These 72 different combinations can be reduced down to a smaller set of combinations that still provide complete pairwise coverage of the Cartesian product space. In particular, the 72 different combinations can be reduced down to 12 distinct combinations that together include every possible pairwise interaction of attribute values. It should be appreciated that a set of test vectors that provides complete m-wise coverage across the attribute values can also be generated (where m>2), but would require a greater number of test vectors that increases logarithmically as m increases.

In some examples, a corresponding set of CTD test cases are generated from the set of CTD test vectors that provides the desired amount of coverage of the test space, and the set of test cases are executed to obtain execution results (e.g., a pass or fail result for each test case). In some examples, based on the execution results, a particular test case may be selected for expansion via an inverse combinatorics technique to obtain a new set of test cases designed to detect and localize a fault in the SUT (e.g., a pairwise error that occurs as a result of the interaction of a particular combination of two different attribute values).

In some examples of the present disclosure, rather than using CTD for testing a SUT, CTD modeling is used to model various computing environment stack possibilities to facilitate the generation of a recommendation that identifies one or more computing environment stack configurations that are appropriate for a particular client or customer. Some examples of the present disclosure include dynamically adjusting CTD model attributes and value sets based on various restrictions or constraints. Such restrictions, for example, may indicate invalid combinations of components of a computing environment stack.

Some examples of the present disclosure are directed to CTD scoring for a sales recommendation engine. Some examples of the present disclosure are directed to a method for recommending hardware/software deployment stack configurations based on cost. Some examples use CTD to create a model of hardware/software deployment stacks. This CTD model may be used to generate the full cartesian product of every attribute combination and every possible stack configuration. Restrictions or constraints may be applied to the CTD model to generate a set of every valid stack configuration. The set of valid stack configurations may then be weighted and sorted based on a criteria which may include, for example, one or more of the following: (1) whether or not the stack configuration was explicitly tested; (2) whether or not any parts of the stack are already owned/available; (3) the cost for purchasing the entirety of the stack; (4) and additional criteria. This results in a weighted list, containing only valid configurations, which serves as a top recommendation set.

Some examples of the present disclosure are directed to a method for a hardware and software configuration engine, which includes identifying a plurality of available hardware components and a plurality of available software components for deployment of a hardware configuration and software stack. The method includes receiving a plurality of requirements for the hardware configuration and software stack. The method includes applying a weight to each of the plurality of requirements. The method includes identifying, based on the applied weights, a set of available hardware components from the plurality of available hardware components and a set of available software components for the hardware configuration and software stack. The method includes generating at least one configuration for the hardware configuration and software stack based on the set of available hardware component and the set of available software components. Some examples disclosed herein provide accelerated verification of hardware configuration and reduced costs of development for new hardware configurations. Some examples include implementation of the hardware and software configuration engine into a physical manufacturing process of the generated configuration.

An example of the present disclosure is directed to a method, which includes generating, by one or more processing devices, a Combinatorial Test Design (CTD) model for identifying possible combinations of stack components for a computing environment stack. The method includes modifying, by the one or more processing devices, the CTD model based on restrictions indicating invalid stack component combinations. The method includes applying, by the one or more processing devices to the CTD model, a plurality of context weights to generate a weighted CTD model. The method includes generating, by the one or more processing devices based on the weighted CTD model and one or more input parameters, a recommended computing environment stack configuration that includes a valid stack component combination.

In some examples of the method, the weighted CTD model models the stack components as a plurality of attributes, and each attribute includes a set of attribute values. In some examples of the method, the recommended computing environment stack configuration include a hardware component, an operating system component, and an application component. In some examples, the recommended computing environment stack configuration further includes a firmware component, a middleware component, and a service component.

In some examples of the method, the plurality of context weights includes one or more weights corresponding to stack component combination testing, one or more weights corresponding to stack component combination availability, and one or more weights corresponding to stack component combination cost to purchase. In some examples, the plurality of context weights further includes one or more weights corresponding to reference architecture patterns, and one or more weights corresponding to stack component combination sales incentives.

In some examples, the method further includes generating, by the one or more processing devices based on the weighted CTD model and the one or more input parameters, a sorted plurality of recommended computing environment stack configurations that each includes a valid stack component combination, where the recommended computing environment stack configurations are sorted based on the context weights and the input parameters. In some examples, the method further includes automatically extracting, by the one or more processing devices, at least a portion of the restrictions from test execution records and support documents for the stack components. In some examples, the method further includes automatically deploying, by the one or more processing devices, at least a portion of the recommended computing environment stack configuration in response to generating the recommended computing environment stack configuration.

Another example of the present disclosure is directed to a computer system, which includes a processor set and one or more computer-readable storage media. The computer system includes program instructions stored on the one or more storage media to cause the processor set to perform operations, which include generating a Combinatorial Test Design (CTD) model for identifying possible combinations of stack components for a computing environment stack. The operations include modifying the CTD model based on restrictions indicating invalid stack component combinations. The operations include applying, to the CTD model, a plurality of context weights to generate a weighted CTD model. The operations include generating, based on the weighted CTD model and one or more input parameters, a recommended computing environment stack configuration that includes a valid stack component combination.

In some examples of the computer system, the weighted CTD model models the stack components as a plurality of attributes, and each attribute includes a set of attribute values. In some examples of the computer system, the recommended computing environment stack configuration include a hardware component, an operating system component, and an application component. In some examples, the recommended computing environment stack configuration further includes a firmware component, a middleware component, and a service component.

In some examples of the computer system, the plurality of context weights includes one or more weights corresponding to stack component combination testing, one or more weights corresponding to stack component combination availability, and one or more weights corresponding to stack component combination cost to purchase. In some examples, the plurality of context weights further includes one or more weights corresponding to reference architecture patterns, and one or more weights corresponding to stack component combination sales incentives.

In some examples of the computer system, the operations further include generating, based on the weighted CTD model and the one or more input parameters, a sorted plurality of recommended computing environment stack configurations that each includes a valid stack component combination, where the recommended computing environment stack configurations are sorted based on the context weights and the input parameters. In some examples of the computer system, the operations further include automatically extracting at least a portion of the restrictions from test execution records and support documents for the stack components.

Another example of the present disclosure is directed to a computer program product, which includes one or more computer-readable storage media. The computer program product includes program instructions stored on the one or more storage media to perform operations, which include generating a Combinatorial Test Design (CTD) model for identifying possible combinations of stack components for a computing environment stack. The operations include modifying the CTD model based on restrictions indicating invalid stack component combinations. The operations include applying, to the CTD model, a plurality of context weights to generate a weighted CTD model. The operations include generating, based on the weighted CTD model and one or more input parameters, a recommended computing environment stack configuration that includes a valid stack component combination.

In some examples of the computer program product, the weighted CTD model models the stack components as a plurality of attributes, and each attribute includes a set of attribute values. In some examples of the computer program product, the recommended computing environment stack configuration include a hardware component, an operating system component, and an application component.

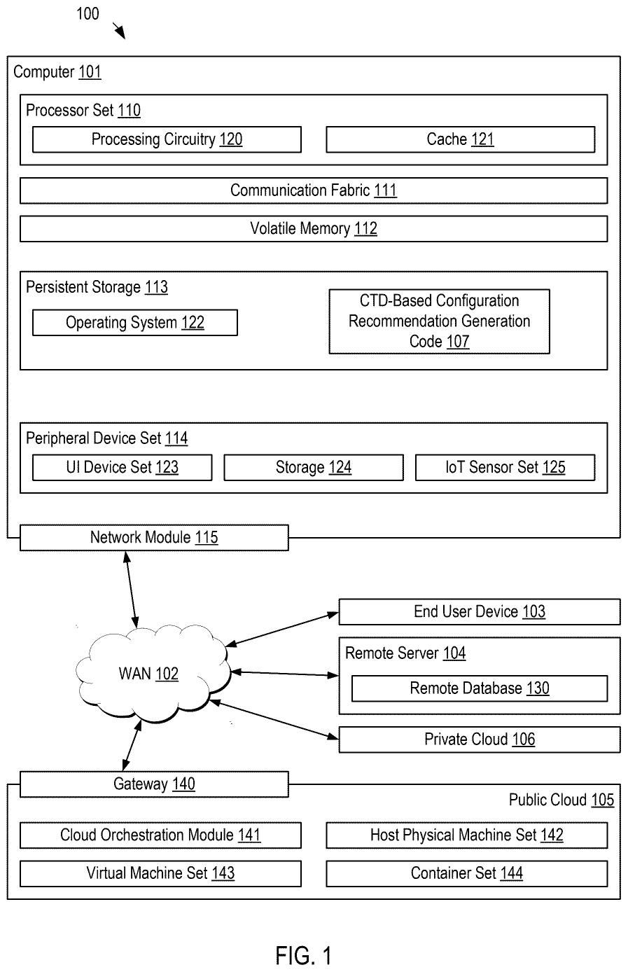

FIG. 1 sets forth an example computing environment according to aspects of the present disclosure. Computing environment 100 contains an example of an environment for the execution of at least some of the computer code involved in performing the various methods described herein, such as CTD-based configuration recommendation generation code 107. In addition to CTD-based configuration recommendation generation code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CTD-based configuration recommendation generation code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in CTD-based configuration recommendation generation code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in CTD-based configuration recommendation generation code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

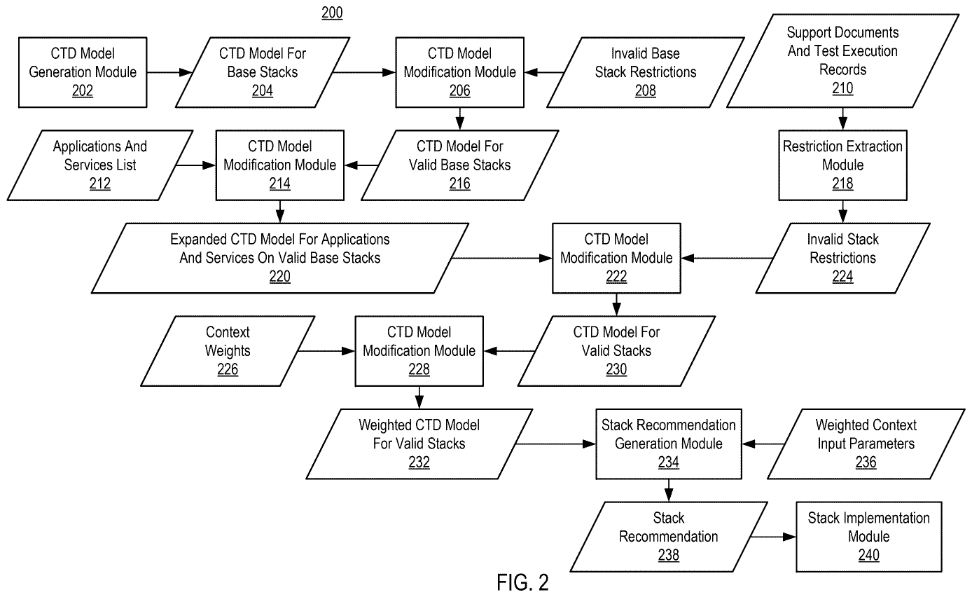

FIG. 2 sets forth an example configuration recommendation generation engine 200 that uses CTD according to aspects of the present disclosure. Engine 200 includes CTD model generation module 202, CTD model modification module 206, CTD model modification module 214, restriction extraction module 218, CTD model modification module 222, CTD model modification module 228, stack recommendation generation module 234, and stack implementation module 240. It is noted that each of the modules 202, 206, 214, 218, 222, 228, 234, and 240 may be implemented with one or more modules, and may be included as part of the CTD-based configuration recommendation generation code 107. One or more of the modules 202, 206, 214, 218, 222, 228, 234, and 240 may also be combined into a single module. For example, the various CTD model modification modules 206, 214, 222, and 228 may be implemented as a single module.

In some examples, components of a computing environment stack may be modeled in a CTD model as a collection of attribute value pairs. Any number of attributes may be used to model the stack components, and each attribute may take on any number of candidate attribute values. For example, hardware of a stack may be represented by a first attribute; firmware of a stack may be represented by a second attribute; software of a stack may be represented by a third attribute; middleware of a stack may be represented by a fourth attribute; an application of a stack may be represented by a fifth attribute; and a service of a stack may be represented by a sixth attribute. Each of the attributes may have any number of candidate attribute values, with each such value corresponding to, for example, a particular version or configuration option.

In some examples, computer-executable instructions of CTD model generation module 202 may be executed to generate CTD model for base stacks 204. In some examples, each base stack is a base portion of a computing environment stack and includes a hardware component, a firmware component, and a software component (e.g., an operating system component). In some examples, the CTD model for base stacks 204 does not yet incorporate any restrictions or constraints on the base stacks, and represents all possible configurations of the base stacks (e.g., all possible combinations of components for the base stacks). The CTD model for base stacks 204 may include a set of attributes and a respective domain of possible values for each attribute. Each component of a base stack may correspond to a particular attribute in the CTD model for base stacks 204.

The CTD model for base stacks 204 and invalid base stack restrictions 208 are provided to CTD model modification module 206. In some examples, computer-executable instructions of CTD model modification module 206 may be executed to modify the CTD model for base stacks 204 based on the invalid base stack restrictions 208 to generate CTD model for valid base stacks 216. In some examples, invalid base stack restrictions 208 indicate invalid combinations of two or more components for base stacks, such as a certain operating system software component being incompatible with a certain hardware component, or a certain application component being incompatible with a certain operating system software component or a certain hardware component. The CTD model for valid base stacks 216 may include a set of attributes, a respective domain of possible values for each attribute, and restrictions on the value combinations across attributes. In some examples, the CTD model for valid base stacks 216 represents all possible configurations of valid base stacks (e.g., all possible combinations of components for valid base stacks). Since invalid base stack combinations are restricted, the possible valid base stacks may include a lesser number of combinations of attribute values than the number for all possible base stack configurations.

The CTD model for valid base stacks 216 and applications and services list 212 are provided to CTD model modification module 214. In some examples, computer-executable instructions of CTD model modification module 214 may be executed to modify the CTD model for valid base stacks 216 based on the applications and services list 212 to generate expanded CTD model for applications and services on valid base stacks 220. In some examples, applications and services list 212 identifies all applications and all services to be incorporated into the model. In some examples, expanded CTD model for applications and services on valid base stacks 220 represents all possible configurations of computing environment stacks that include valid base stacks.

Support documents and test execution records 210 are provided to restriction extraction module 218. In some examples, support documents and test execution records 210 are two different sources of information. The support documents include one or more support documents for each application and each service in the model, and the support documents for a given application or service indicate supported configurations of that application or service, and may indicate what other components the application or service does or does not work with. Support documents and test execution records 210 also include test execution records that indicate successes and/or failures in testing individual components and/or combinations of components of computing environment stacks, such as testing that indicates invalid configuration defects. In some examples, computer-executable instructions of restriction extraction module 218 may be executed to automatically extract constraints or restrictions from the support documents and test execution records 210 and generate invalid stack restrictions 224. The invalid stack restrictions 224 may indicate invalid combinations of two or more components for computing environment stacks. The restrictions may be built up in levels. For example, if it is known that component A does not work with component B, then a combination of component A, component B, and component C may be deemed to be invalid even if it is claimed that component C works with component A and component B. The restriction extraction module 218 may include an artificial intelligence (AI) module to facilitate the identification and extraction of the restrictions from the support documents and test execution records 210.

The expanded CTD model for applications and services on valid base stacks 220 and invalid stack restrictions 224 are provided to CTD model modification module 222. In some examples, computer-executable instructions of CTD model modification module 222 may be executed to modify the expanded CTD model applications and services on valid base stacks 220 based on the invalid stack restrictions 224 to generate CTD model for valid stacks 230. In some examples, the CTD model for valid stacks 230 represents possible configurations of valid computing environment stacks (e.g., possible combinations of components for the computing environment stacks).

The CTD model for valid stacks 230 and context weights 226 are provided to CTD model modification module 228. In some examples, each weight in context weights 226 corresponds to one of a plurality of different contexts or categories. The contexts may include, for example: (1) component combination testing-whether a particular combination of two or more particular components of a computing environment stack configuration have been tested together; (2) stack testing-whether a particular computing environment stack configuration has been tested; (3) reference architecture pattern-whether a particular computing environment stack configuration corresponds to a reference architecture pattern; (4) sales incentive-whether a particular computing environment stack configuration and/or one or more components of the stack configuration are included as part of a current sales incentive program; (5) cost-the cost of a particular computing environment stack configuration and/or one or more components of the stack configuration; and (6) stack component availability-whether a particular component is available to be included in a stack configuration. In some examples, additional and/or different contexts or categories may be used for context weights 226.

In some examples, computer-executable instructions of CTD model modification module 228 may be executed to modify the CTD model for valid stacks 230 based on the context weights 226 to generate weighted CTD model for valid stacks 232. In some examples, the weighted CTD model for valid stacks 232 represents possible configurations of valid computing environment stacks (e.g., possible valid combinations of components for the computing environment stacks) with context weighting included in the model. The weighted CTD model for valid stacks 232 may include a set of attributes, a respective domain of possible values for each attribute, restrictions on the value combinations across attributes, and context weighting.

The weighted CTD model for valid stacks 232 and weighted context input parameters 236 are provided to stack recommendation module 234. In some examples, the weighted context input parameters 236 include user preferences regarding a computing environment stack configuration, such as the preferences of a client, customer, or other individual or entity to which a stack recommendation is to be provided. The weighted context input parameters 236 may correspond to the context weights 226. For example, the weighted context input parameters 236 may indicate user preferences regarding component combination testing, stack testing, reference architecture patterns, sales incentives, cost, stack component availability. The user preferences may also represent the preferences of multiple individuals or entities, such as a customer's preferences regarding testing and cost, and a sales team's preferences regarding sales incentives. Some customers may only be interested in a computing environment stack configuration that has been tested and verified as working properly and that corresponds to a reference architecture pattern. Other customers may only be interested in a computing environment stack that does not exceed a particular price threshold.

In some examples, computer-executable instructions of stack recommendation generation module 234 may be executed to generate a stack recommendation 238 based on the weighted CTD model for valid stacks 232 and the weighted context input parameters 236. In some examples, the stack recommendation generation module 234 may use the weighted context input parameters 236 as filters to map against the weighted CTD model for valid stacks 232 to identify one or more computing environment stack configurations that best match user preferences as indicated by the weighted context input parameters 236. The stack recommendation 238 may include a single recommended computing environment stack configuration, or may include a sorted list of two or more computing environment stack configurations (e.g., sorted into an order from a highest recommended stack configuration to a lowest recommended stack configuration) based on how closely each recommended stack configuration matches the user preferences.

In some examples, the stack recommendation 238 is a sales recommendation that may be generated by a sales team using the stack recommendation generation module 234. The stack recommendation 238 may include one or more recommended computing environment stack configurations, as well as pricing information and other information regarding the recommended stack configurations and components of the stacks. In some examples, the stack recommendation 238 is provided to stack implementation module 240 for automatically implementing one or more recommended computing environment stack configurations or portions of one or more recommended computing environment stack configurations. For example, stack implementation module 240 may cause one or more recommended computing environment stack configurations or portions of one or more recommended computing environment stack configurations to be automatically deployed. The automatic deployment may be in response to user input, such as in response to a customer purchase, or may occur automatically in response to the generation of the stack recommendation 238.

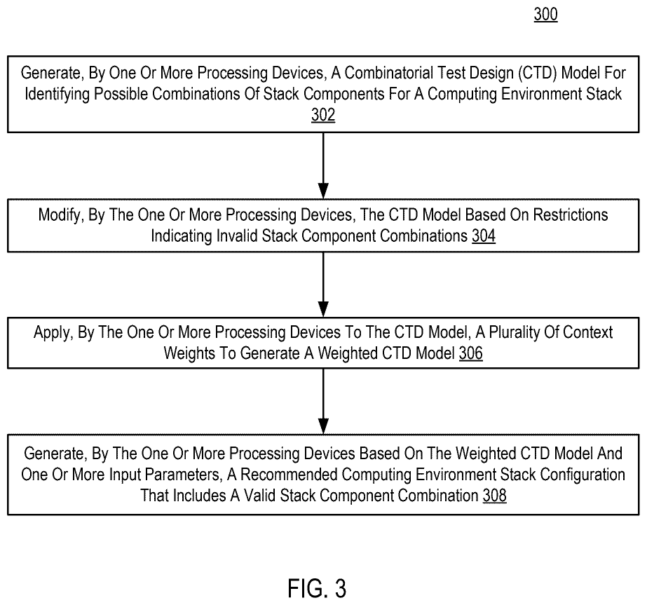

FIG. 3 sets forth a flowchart of an example method 300 for CTD-based configuration recommendation generation according to aspects of the present disclosure. In a particular embodiment, the method 300 of FIG. 3 is performed by configuration recommendation generation engine 200 (FIG. 2) using CTD-based configuration recommendation generation code 107 (FIG. 1). The method 300 of FIG. 3 includes generating 302, by one or more processing devices, a Combinatorial Test Design (CTD) model for identifying possible combinations of stack components for a computing environment stack. The method 300 includes modifying 304, by the one or more processing devices, the CTD model based on restrictions indicating invalid stack component combinations. The method 300 includes applying 306, by the one or more processing devices to the CTD model, a plurality of context weights to generate a weighted CTD model. The method 300 includes generating 308, by the one or more processing devices based on the weighted CTD model and one or more input parameters, a recommended computing environment stack configuration that includes a valid stack component combination.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating, by one or more processing devices, a Combinatorial Test Design (CTD) model for identifying possible combinations of stack components for a computing environment stack;
modifying, by the one or more processing devices, the CTD model based on restrictions indicating invalid stack component combinations;
applying, by the one or more processing devices to the CTD model, a plurality of context weights to generate a weighted CTD model; and
generating, by the one or more processing devices based on the weighted CTD model and one or more input parameters, a recommended computing environment stack configuration that includes a valid stack component combination.

2. The method of claim 1, wherein the weighted CTD model models the stack components as a plurality of attributes, and wherein each attribute includes a set of attribute values.

3. The method of claim 1, wherein the recommended computing environment stack configuration include a hardware component, an operating system component, and an application component.

4. The method of claim 3, wherein the recommended computing environment stack configuration further includes a firmware component, a middleware component, and a service component.

5. The method of claim 1, wherein the plurality of context weights includes one or more weights corresponding to stack component combination testing, one or more weights corresponding to stack component combination availability, and one or more weights corresponding to stack component combination cost to purchase.

6. The method of claim 5, wherein the plurality of context weights further includes one or more weights corresponding to reference architecture patterns, and one or more weights corresponding to stack component combination sales incentives.

7. The method of claim 1, and further comprising:
generating, by the one or more processing devices based on the weighted CTD model and the one or more input parameters, a sorted plurality of recommended computing environment stack configurations that each includes a valid stack component combination, wherein the recommended computing environment stack configurations are sorted based on the context weights and the input parameters.

8. The method of claim 1, and further comprising:
automatically extracting, by the one or more processing devices, at least a portion of the restrictions from test execution records and support documents for the stack components.

9. The method of claim 1, and further comprising:
automatically deploying, by the one or more processing devices, at least a portion of the recommended computing environment stack configuration in response to generating the recommended computing environment stack configuration.

10. A computer system comprising:
a processor set;
one or more computer-readable storage media; and
program instructions stored on the one or more storage media to cause the processor set to perform operations comprising:
generating a Combinatorial Test Design (CTD) model for identifying possible combinations of stack components for a computing environment stack;
modifying the CTD model based on restrictions indicating invalid stack component combinations;
applying, to the CTD model, a plurality of context weights to generate a weighted CTD model; and
generating, based on the weighted CTD model and one or more input parameters, a recommended computing environment stack configuration that includes a valid stack component combination.

11. The computer system of claim 10, wherein the weighted CTD model models the stack components as a plurality of attributes, and wherein each attribute includes a set of attribute values.

12. The computer system of claim 10, wherein the recommended computing environment stack configuration include a hardware component, an operating system component, and an application component.

13. The computer system of claim 12, wherein the recommended computing environment stack configuration further includes a firmware component, a middleware component, and a service component.

14. The computer system of claim 10, wherein the plurality of context weights includes one or more weights corresponding to stack component combination testing, one or more weights corresponding to stack component combination availability, and one or more weights corresponding to stack component combination cost to purchase.

15. The computer system of claim 14, wherein the plurality of context weights further includes one or more weights corresponding to reference architecture patterns, and one or more weights corresponding to stack component combination sales incentives.

16. The computer system of claim 10, wherein the operations further comprise:
generating, based on the weighted CTD model and the one or more input parameters, a sorted plurality of recommended computing environment stack configurations that each includes a valid stack component combination, wherein the recommended computing environment stack configurations are sorted based on the context weights and the input parameters.

17. The computer system of claim 10, wherein the operations further comprise:
automatically extracting at least a portion of the restrictions from test execution records and support documents for the stack components.

18. A computer program product comprising:
one or more computer-readable storage media; and
program instructions stored on the one or more storage media to perform operations comprising:
generating a Combinatorial Test Design (CTD) model for identifying possible combinations of stack components for a computing environment stack;
modifying the CTD model based on restrictions indicating invalid stack component combinations;
applying, to the CTD model, a plurality of context weights to generate a weighted CTD model; and
generating, based on the weighted CTD model and one or more input parameters, a recommended computing environment stack configuration that includes a valid stack component combination.

19. The computer program product of claim 18, wherein the weighted CTD model models the stack components as a plurality of attributes, and wherein each attribute includes a set of attribute values.

20. The computer program product of claim 18, wherein the recommended computing environment stack configuration include a hardware component, an operating system component, and an application component.
